(19) United States
(12) Patent Application Publication
(10) Pub. No.: US 2006/0281043 A1
(43) Pub. Date: Dec. 14, 2006

(54) Dental modeling assembly and methods

(76) Inventor: Ronald E. Huffman, Oro Valley, AZ (US)

Correspondence Address: MERCHANT & GOULD PC, P.O. BOX 2903, MINNEAPOLIS, MN, 55402-0903, US

(21) Appl. No.: 11/150,849

(22) Filed: Jun. 10, 2005

(51) Int. Cl. A61C 19/00; A61C 11/00

(52) U.S. Cl. 433/50; 433/57; 433/65

(57) ABSTRACT

A method and dental modeling system of forming a dental model from a mold of a person's teeth using a dental modeling system. The dental modeling system includes an opposing model base, a model base, and a pouring jig. The pouring jig includes a mold support member and a model support member. The mold may include impressions of a patient's opposing upper and lower teeth formed on opposite sides of the mold. The method may include mounting the opposing model base to the mold support member, filling the opposing model base and teeth impressions on one side of the mold with a first moldable material and mating the filled first moldable material, and mounting the model base to the model support member. The method further includes aligning the model base with teeth impressions on an opposing side of the mold, filling the opposing side of the mold with a second moldable material and mating the filled second moldable material with the model base, and curing the first and second moldable materials to form a dental model that includes opposing top and bottom teeth molds.

### BACKGROUND

1. Technical Field

The invention relates to dental models and methods of forming dental models. More particularly, the invention relates to an adjustable dental model pouring jig and a method of using the same.

2. Related Art

Traditional dental model pouring jigs and apparatuses for creating a dental model from a mold of a person's teeth have been in use for many decades. The mold is typically formed by having a patient bite into a pliant casting material, which cures to create a mold cavity having a negative impression of the patient's teeth and gums. The mold can be of all or any portion of the patient's gum line. A castable material is then poured into the negative impression to create a stone replica or dental model of the patient's teeth and gums.

The primary function of a dental pouring jig is to support the mold of a person's teeth in a position relative to a dental model base or pins associated with particular teeth when creating a model of the teeth. This function can be especially difficult when creating dental models from specialized dental molds that provide an impression of both the top and bottom sets of teeth in a person's mouth. These specialized molds are sometimes referred to as “triple trays.” Triple trays are most often used to create simultaneously a dental model of a damaged tooth on either the top or bottom of a person's mouth and an opposing dental model of teeth facing the damaged tooth.

Known pouring jigs have many disadvantages and are unequipped to handle specialized dental molds such as triple trays. The adjustment features of known pouring jigs, if available, are typically awkward and difficult to adjust with precision. Further, typically only those pouring jig features holding the mold or the features holding the pins or dental model base are adjustable. With this limited adjustability, it is difficult to position the mold and the pins or dental model base in a precise way relative to each other when creating the dental model.

Other disadvantages associated with known pouring jigs include the amount of time required to make adjustments to the pouring jig and the inability to recreate adjusted positions. Also, known pouring jigs are typically configured for a single mold and dental model base size, such as, for example, a size that reflects a large, medium or small sized mouth. A yet further limitation of known pouring jigs relates to handling different types of dental model bases with the same pouring jig.

### SUMMARY

The present disclosure generally relates to dental modeling systems and related methods of forming a dental model from a mold of a person's teeth. More particularly, the present disclosure relates to adjustable dental model pouring jigs and a method of using a pouring jig, pin locators, dental model bases, and opposing dental model bases to create a dental model from a mold of a person's teeth.

One aspect of the present disclosure relates to a dental modeling system that includes a model base, an opposing model base, and a pouring jig. The model base includes a first model support surface configured for mounting a model of at least some of a person's upper or lower teeth. The opposing model base defines a second model support surface configured for mounting an opposing model of at least some of the person's teeth that are aligned opposite in a patient's mouth from the teeth model mounted on the model base. The pouring jig includes a support base, a mold support member, and a model support member. The mold support member is mounted to the support base and includes a stand, a mold platform supported on the stand, and adjustment features configured to adjust an orientation of the mold platform relative to the support base. The platform is configured to releaseably mount the opposing model base. The model support member is mounted to the support base and the model support member is configured to support the model base in a position generally vertically above the opposing model base.

Another aspect of the invention relates to a method of forming a dental model from a mold of a person's teeth using a dental modeling system. The dental modeling system includes an opposing model base, a model base, and a pouring jig. The pouring jig includes a mold support member and a model support member, and the mold includes impressions of a patient's opposing upper and lower teeth formed on opposite sides of the mold. The method steps include mounting the opposing model base to the mold support member, filling the opposing model base and teeth impressions on one side of the mold with a first moldable material, mating the filled first moldable material in the opposing model base and the one side of the mold, and mounting the model base to the model support member. The method further includes aligning the model base with teeth impressions on an opposing side of the mold, filling the opposing side of the mold with a second moldable material, and mating the filled second moldable material with the model base. The method further includes curing the first and second moldable materials to form a dental model that includes opposing top and bottom teeth, and removing the mold from the cured moldable material.

A further aspect of the invention relates to a dental model base that includes a bottom wall, a first sidewall, a plurality of retaining pins, and first and second attachment features. The first sidewall extends continuously and in a generally vertical direction from the bottom wall. The sidewall defines a top support surface along a top edge of the first sidewall. The bottom wall and the first sidewall define a first cavity. The retaining pins extend generally vertically from the bottom wall into the cavity and are maintained below the top support surface. The first attachment feature is defined in a front end of the sidewall and the second attachment feature is defined in a rear end of the sidewall.

The above summary of the present invention is not intended to describe each embodiment or every implementation of the present invention. The Figures and the detailed description that follow more particularly exemplify a preferred embodiment.

### BRIEF DESCRIPTION OF THE DRAWINGS

The invention may be more completely understood in consideration of the following detailed description of preferred embodiments of the invention in connection with the accompanying drawings, in which:

FIG. 1 is a front top perspective view of an example dental modeling system comprising a pouring jig, a full arc opposing dental model base, and a pin locator;

FIG. 2 is a front top perspective view of the dental modeling system shown in FIG. 1 and further includes a full arc dental mold;

FIG. 3 is an exploded front top perspective view of the dental modeling system shown in FIG. 2;

FIG. 4 is an exploded front bottom perspective view of the dental modeling system shown in FIG. 2;

FIG. 5 is a rear top perspective view of the opposing dental model base shown in FIGS. 1-3;

FIG. 6 is a front top perspective view of the dental modeling system shown in FIG. 1 comprising a quadrant opposing dental model base;

FIG. 7 is a front top perspective view of the dental modeling system shown in FIG. 6 and further includes a quadrant dental mold;

FIG. 8 is a rear bottom perspective view of the quadrant opposing dental model base shown in FIG. 6;

FIG. 9 is a rear bottom perspective view illustrating features of the locking assembly of the pouring jig base member shown in FIG. 1;

FIG. 10 is a perspective view illustrating features of the pouring jig mold support stand shown in FIG. 1;

FIG. 11 is a perspective view illustrating features of the pouring jig mold support platform adjuster shown in FIG. 1;

FIGS. 12-16 illustrate example method steps for forming a dental model using the dental modeling system shown in FIG. 2 and a dental model base;

FIG. 17 is a rear perspective view showing the full arc opposing dental model base, dental mold and dental model combined according to the steps shown in FIGS. 12-16 and coupled to a disposable articulator;

FIG. 18 is a front perspective view showing a quadrant opposing dental model base mounted to an articulator with a plaster attachment; and

FIG. 19 is a front perspective view of the quadrant opposing dental model base shown in FIG. 18 mounted to the articulator with an attachment plate, wherein the attachment plate is mounted to the articulator with a plaster attachment.

While the invention is amenable to various modifications and alternative forms, the specifics thereof have been shown by way of example in the drawings and will be described in detail. It should be understood, however, that the intention is not to limit the invention to the particular embodiment described. On the contrary, the intention is to cover all modifications, equivalents, and alternatives falling with in the spirit and scope of the invention.

### DETAILED DESCRIPTION

The present disclosure is applicable to dental modeling systems and methods that utilize pouring jigs to create a dental model and a corresponding opposing dental model. The present disclosure also relates to dental model bases for use in generating opposing dental models and methods of using the same. In particular, the present disclosure is directed to dental model pouring jigs that include multiple adjustment features providing adjustability in multiple planes. The example pouring jigs disclosed are configured for generating different types of dental models from different types of dental molds. While the present disclosure may not be so limited, an appreciation of various aspects of the present disclosure will be gained through a discussion of the examples provided below.

Pouring jigs have been used extensively to assist in creating a dental model from a mold or impression of a person's teeth. Typically, a pouring jig supports a mold of a person's teeth and a dental model base adjacent to the mold. Known pouring jigs are difficult to precisely adjust for the purpose of aligning the dental model base relative to the dental mold. Known pouring jigs ineffectively repeat similar functions or return to a previously adjusted position. Known pouring jigs are also inadequate for the purpose of forming dental models and associated opposing dental models from “triple tray” dental molds (i.e., dental molds that include impressions of a person's opposing upper and lower teeth). The present disclosure, with reference to the accompanying figures, provides a dental modeling system with a related pouring jig and dental model bases that addresses these and other shortcomings of the art.

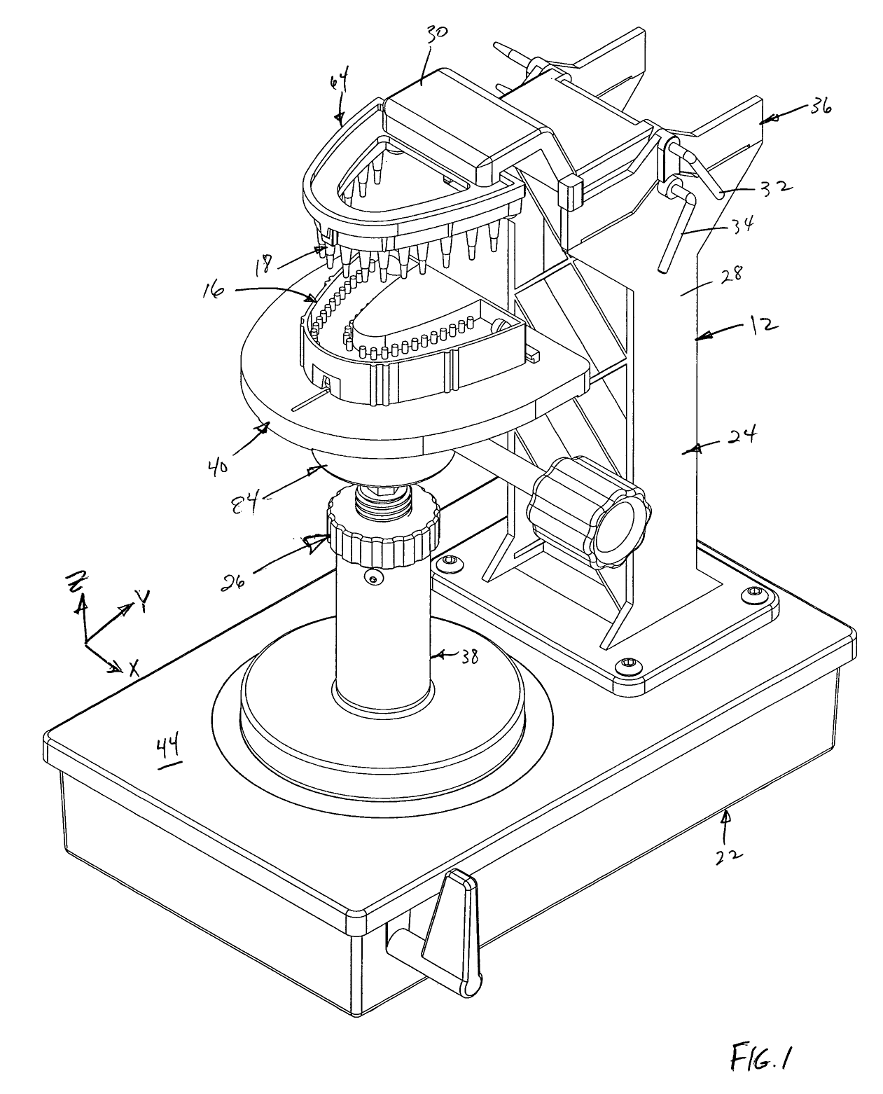

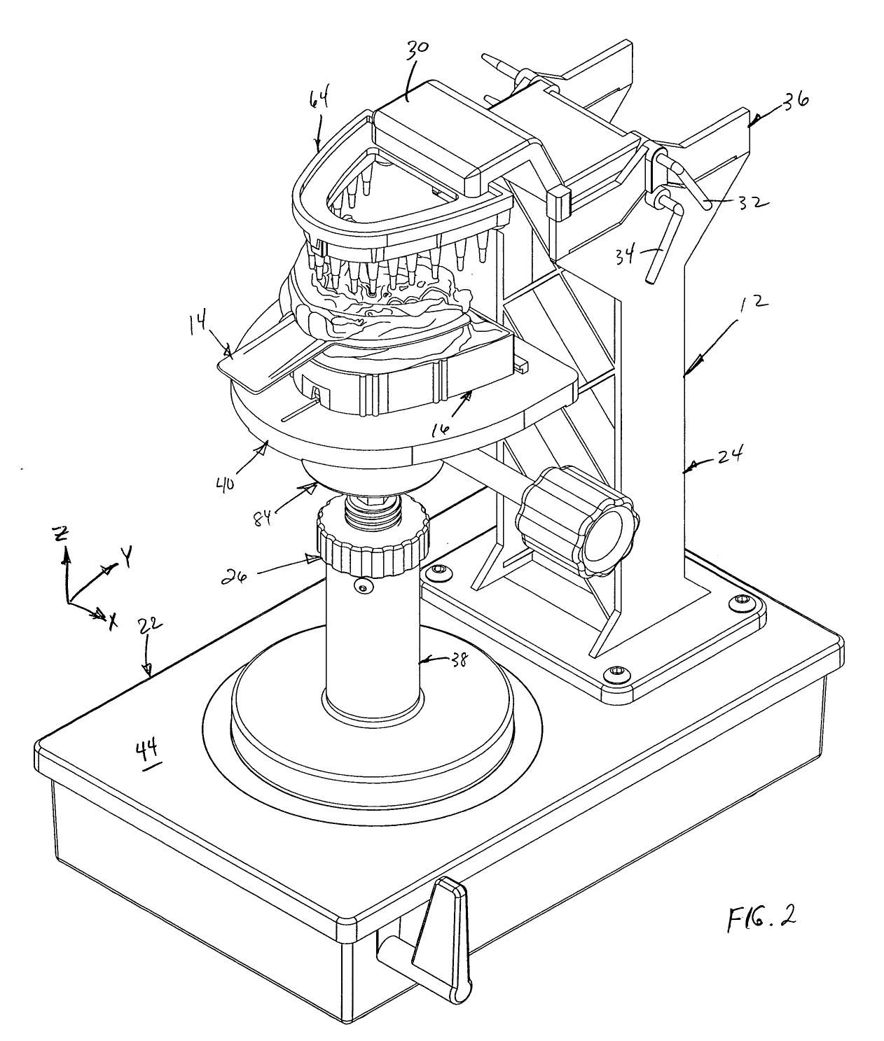

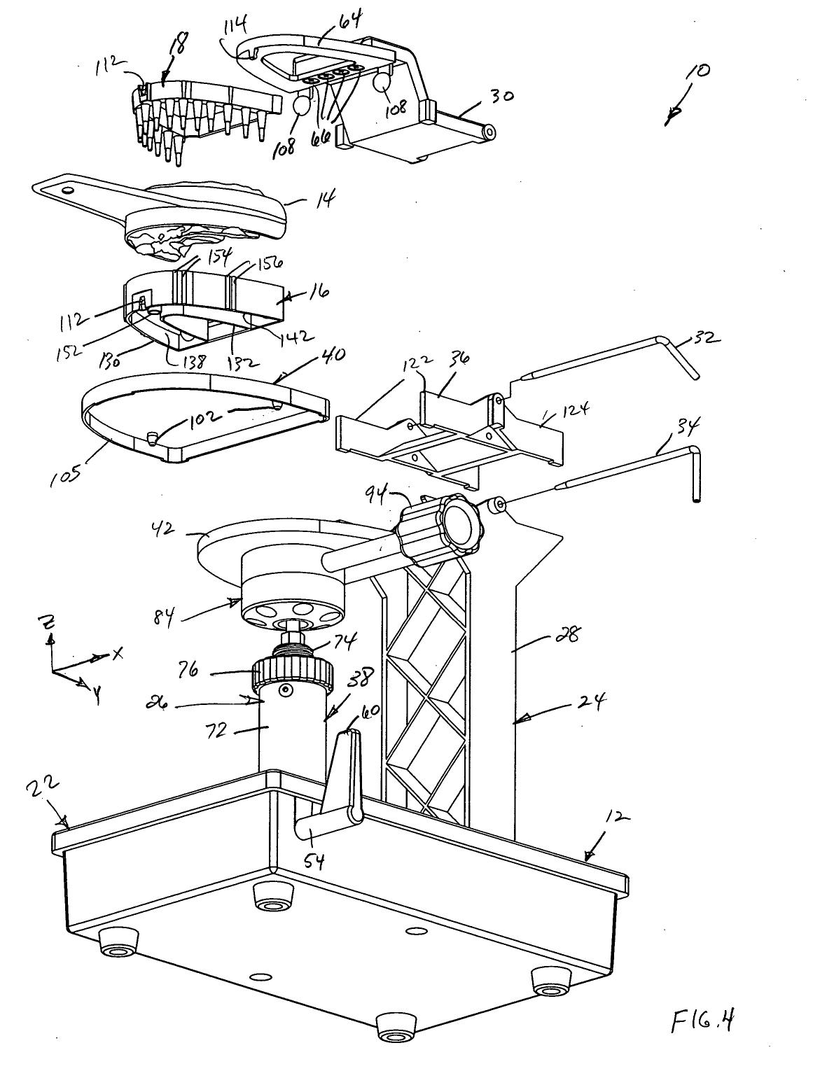

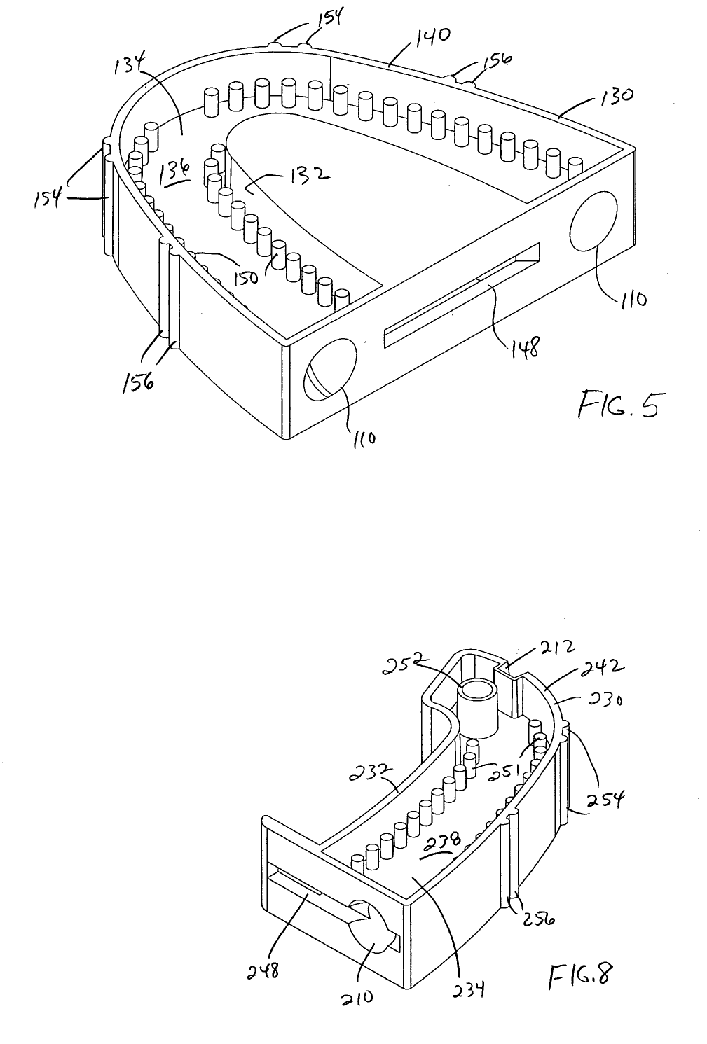

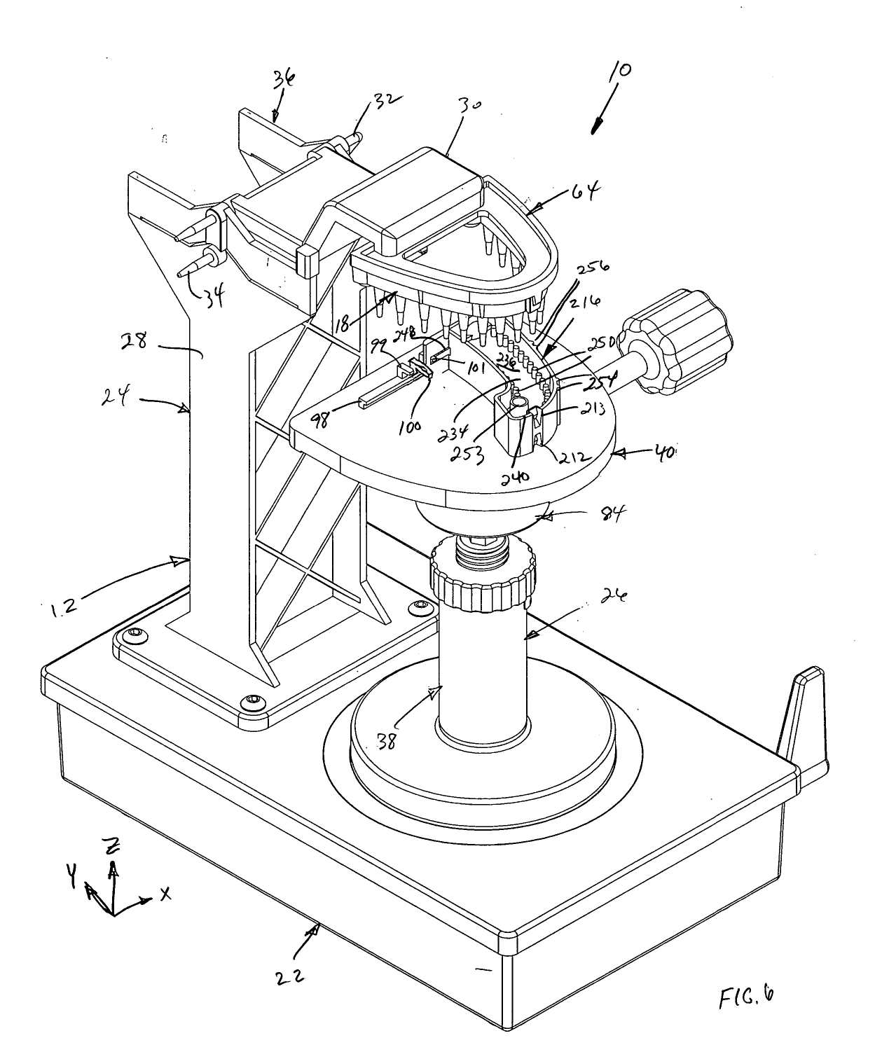

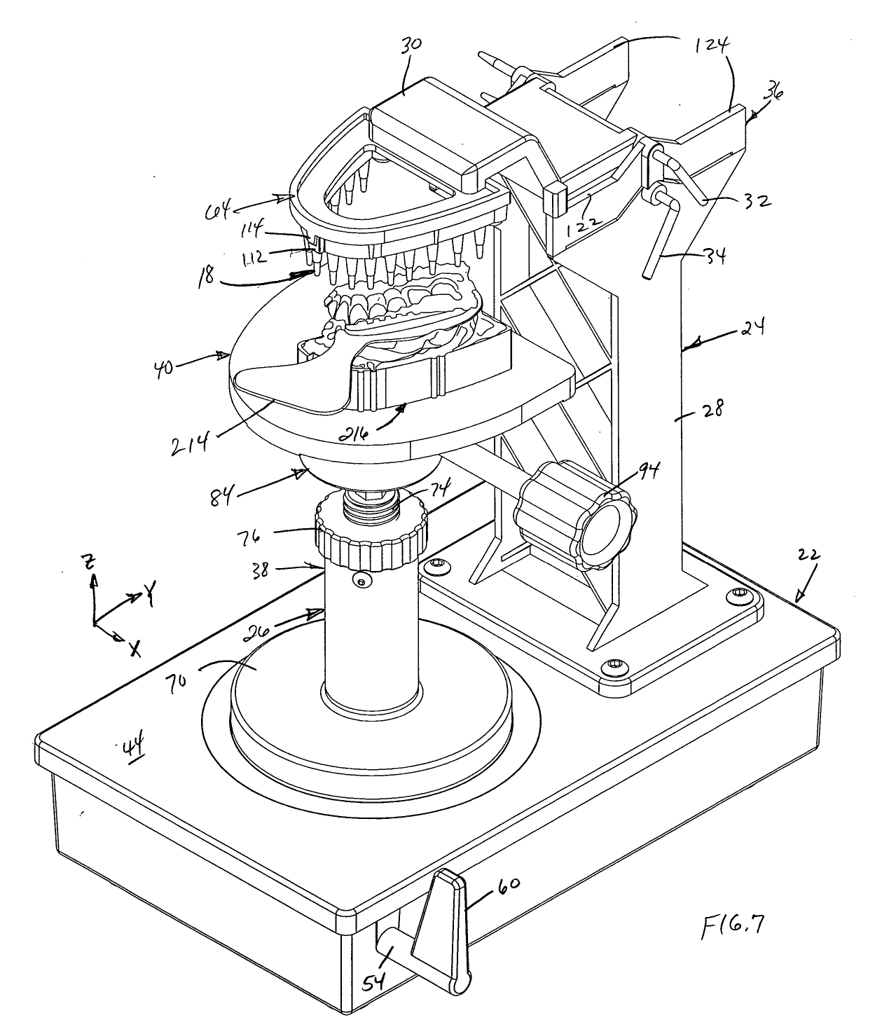

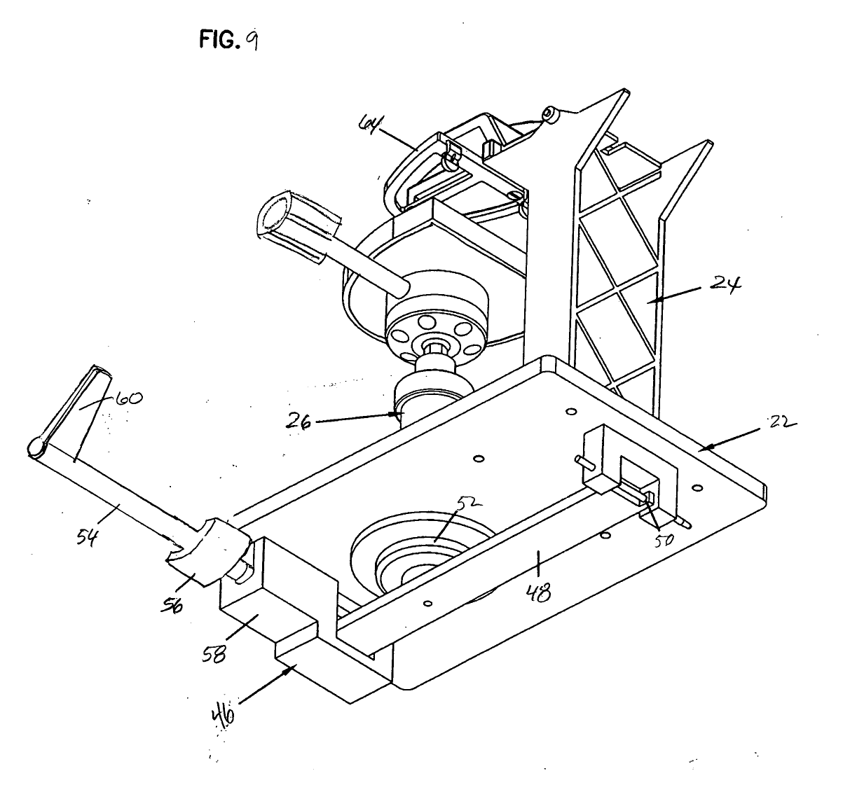

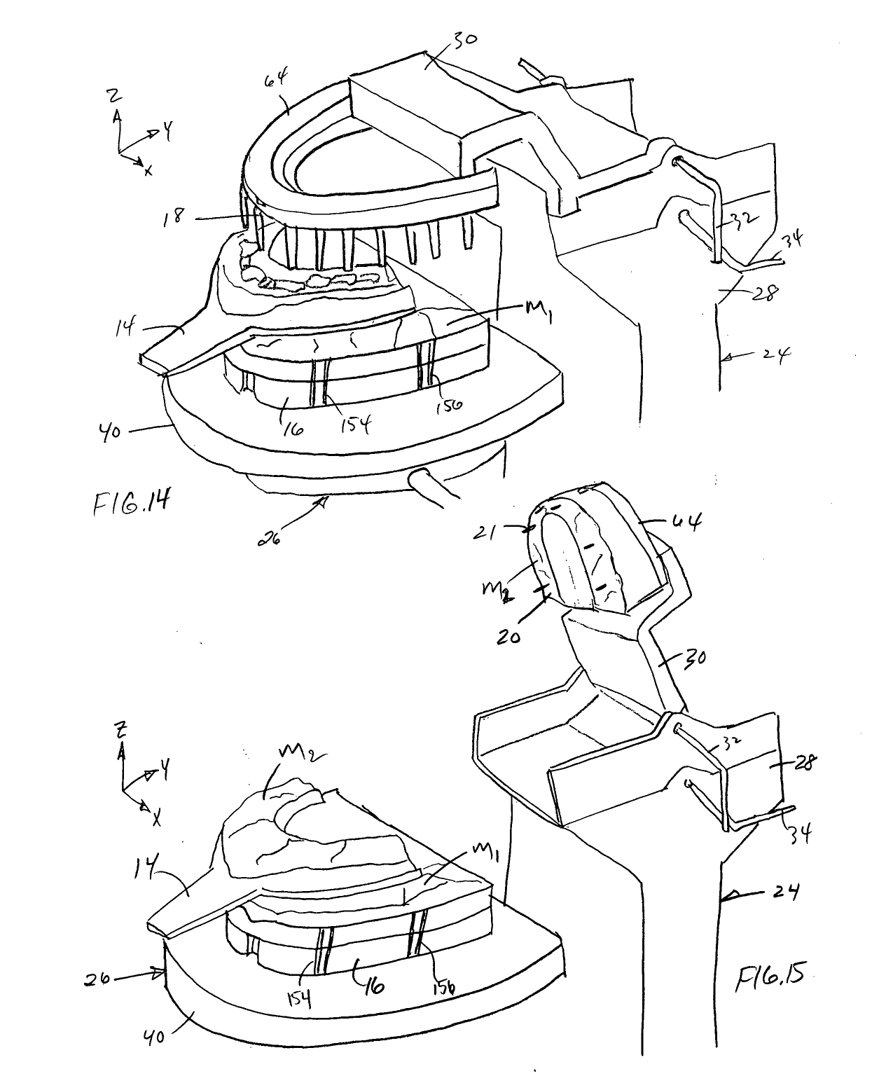

FIG. 1 illustrates an example dental modeling system 10 for forming opposing dental models. The system 10 includes a pouring jig 12, a full arc opposing dental model base 16 (“opposing base” or “full arc opposing base”), and a pin locator 18. Features of the opposing base 16 are provided below with reference to FIGS. 4 and 5. The pin locator 18 is replaceable on the pouring jig 10 with a dental model base 20 (see FIGS. 15-17) in final steps of the modeling process. FIGS. 2-4 illustrate the modeling system 10 further including a full arc triple tray dental mold 14 that includes impressions on a patient's opposing upper and lower teeth.

FIG. 6 illustrate the dental modeling system 10 with a quadrant opposing dental model base 216 (“quadrant opposing base”), and FIG. 7 further illustrates a quadrant triple tray dental mold 214 with the quadrant opposing dental model base 216. Features of the quadrant opposing base 216 are discussed below with reference to FIGS. 6 and 8.

Pouring jig 12 includes a base member 22, a model base support member 24, and a mold support member 26. Model base support member 24 includes a first portion 28 secured to base member 22, and a second portion 30 that is pivotally secured to the first portion with pivot rods 32, 34 and an extension 36. The mold support member 26 includes a stand portion 38, a mold platform 40, and a platform support 42. The stand portion 38 is adjustable in the X, Y plane and in the Z direction to alter a position of the mold platform 40 relative to base member 22. The mold platform 40 and platform support 42 are together pivotally adjustable relative to the stand portion 38. Thus, the mold support member 26 provides adjustability in multiple directions to facilitate the pouring and creation of a dental model.

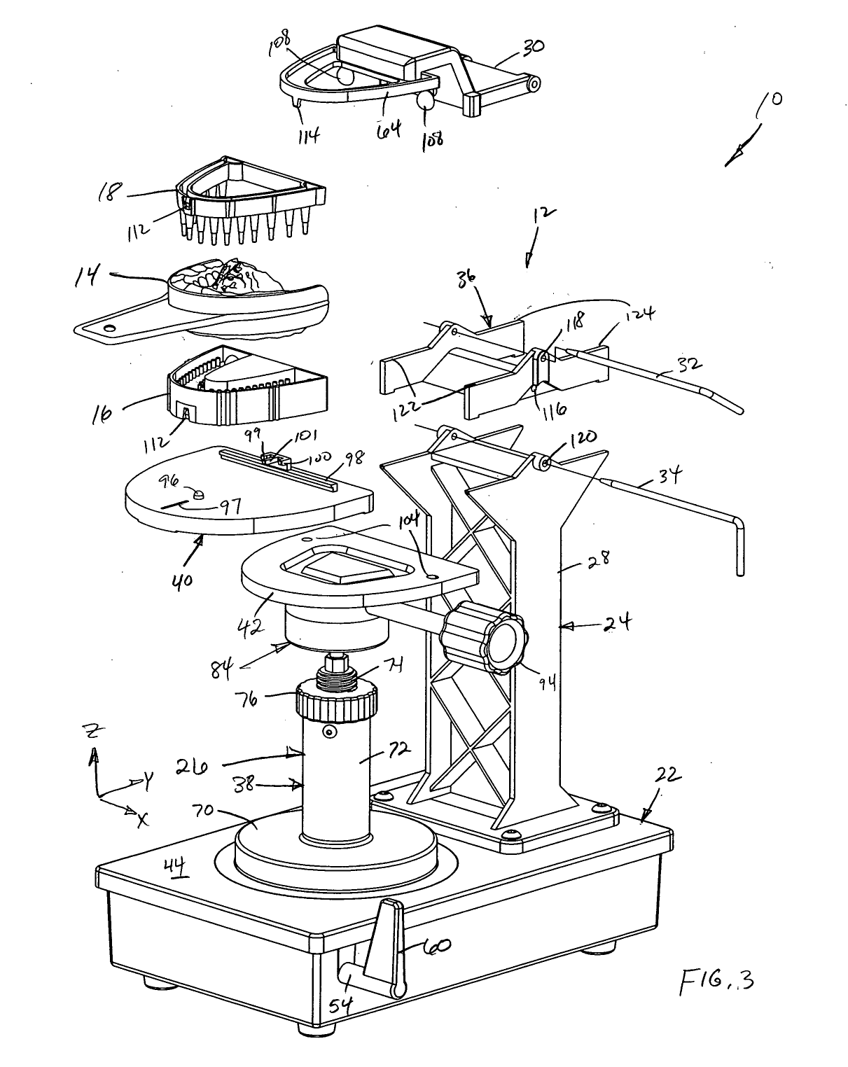

Referring now to FIG. 9, the base member 22 includes a locking mechanism 46 that may be used to lock or hold mold support member 26 in a given XY position on a top surface 44 of the base member (see FIG. 1). Locking mechanism 46 includes a pivot member 48, a pivot point 50, a locking portion 52, a lever 54, a cam portion 56 secured to the lever 54 (see FIG. 3), and a lever bracket 58. The pivot member 48 is secured at the pivot point 50 on one end and is engaged by the cam portion 56 of lever 54 near an opposing end. Locking portion 52 is mounted to the pivot member preferably at some point between the pivot point 50 and the location where the cam portion 56 engages the pivot member 48. The cam portion 56 preferably engages pivot member 48 at a point as far from pivot point 50 as possible in order to create the greatest amount of leverage for disengaging locking portion 52 from the mold support member 26.

Cam portion 56 includes a cam surface having a predetermined cam surface angle that provides an amount of force necessary to disengage the locking portion 52 from the mold support member 26 when the lever 54 rotates. Cam portion 56 is also configured to restrict the rotation of lever 54 to a predetermined amount of rotation. The lever handle 60 is in an upright position when locking portion 52 is in the locked position, and is rotated through about 90 degrees to disengage the locking portion 52 from the mold support member 26. In other embodiments, the lever 54 may rotate through greater or smaller angles of rotation to engage and disengage the locking portion 52. Further, the lever handle 60 may be arranged in any desired position relative to the base.

Locking portion 52 may comprise a magnetic material that provides magnetic forces strong enough to hold mold support member 26 in a given XY position on top surface 44 of the base member 22. The strength of the magnetic forces are typically strong enough to hold the mold support member 26 in a given position to prohibit the inadvertent movement of the mold support member 26, but allow the locking portion to be easily releasable for adjusting the mold support member 26 relative to the base member 22.

In other embodiments, locking mechanism 46 may be configured differently, having different components and features for locking the mold support member 26 in a given XY position. For example, the locking mechanism 46 may include a ball and socket configuration wherein the ball is secured to the mold support member and the socket portion, when tightened, secures the mold support member 26 to base member 22 in a fixed position. Another example embodiment of locking mechanism 22 may include a threaded shaft with a nut, wherein tightening the nut secures the mold support member 26 against the base member at a desired XY position.

Referring again to FIGS. 1-4, the model base support member 24 further includes an attachment plate 64 to which a dental model base 20 (see FIGS. 15-17) or the pin locator 18 may be attached. The attachment plate 64 is secured to second portion 30 at connecting points 66, 68 with fasteners, adhesives, or the like.

Typically, second portion 42 is configured for attachment of a particular attachment plate size or a specific dental model base size. For example, there may be a different attachment plate and dental model sizes for an adult sized mouth (large), a youth sized mouth (medium), and a child sized mouth (small). An appropriate sized second portion 30 may be used for a given mold size by removing pivot rod 32 and replacing the second portion 30 with the proper sized second portion.

In other embodiments, a specific sized second portion 30 may be permanently fixed to first portion 28. This configuration may provide for set up of separate pouring jigs for each of the large, medium or small attachment plate and dental model base sizes.

The model base support member 24 illustrated in FIGS. 1-4 provides movement of the second portion 30 between a first position shown in FIGS. 1-4 and a second position shown, for example, in FIG. 15. When in the first position, the second portion 30 orients the dental model base 20 or pin locator 18, which is supported by the second portion 30, adjacent to the dental mold 14 while the mold 14 is positioned on the mold platform 40. When in the second position, the dental model base 20 or pin locator 18 is pivotally removed from dental mold 14. In the embodiment illustrated in FIGS. 1-4, the second portion 42 can pivot about 180 degrees between the first and second positions so that in the second position the dental model base or pin locator is facing upward rather than the generally downward facing arrangement of the first position. In other embodiments, the rotation angle may be in the range of about 30 to about 270 degrees, and preferably between about 100 and about 180 degrees.

Moving the second portion 30 into the second position may provide easier access to mounting features such as the connecting points 66 (see FIG. 4), which are used to mount the attachment plate, pin locator, or dental model base to the second portion 30. Also, when in the second position, it may be easier to arrange pins in the dental model base and prepare the pins for insertion into the mold by, for example, pre-covering the pins with a layer of model forming material to ensure that the pins are properly secured within the resulting model.

In other embodiments, the connecting points 66 may be configured differently for mounting different attachment plates, pin locators, and dental model bases. For example, there may be more or less than the four connecting points 66 shown in FIG. 4 depending on the design of the piece that is being connected to the second portion 30.

The pin locator 18 is comparable in some respects to the dental model base configurations referenced in the above U.S. patents and patent applications listed below, in that it can be configured with features that provide quick release from the attachment plate. The pin locator 18 may include a variety of different pin numbers and pin arrangements. Pin locator 18 may include relatively long pins (as compared to pins of a dental model base) that extend from the pin locator for improved visual alignment and positioning of the pin locator 18 relative to teeth impressions in a dental mold. During the modeling process, the pin locator is replaced with a dental model base after the mold is properly positioned relative to the pin locator and prior to filling the dental mold with moldable material. Preferably, the total height of the pin locator (e.g., length of the pins plus the height of a base portion of the pin locator) is substantially equal to the total height of the base (length of the pins extending from the dental model base plus the height of the dental model base). With equal heights provided, a fine adjustment of position of the pin locator pins relative to teeth impression in the dental mold provides a like adjustment of corresponding pins in the dental model base when the pin locator is replaced by the dental model base. Further details related to the structure and function of pin locator 18 are provided in U.S. Published Patent Application Nos. 2004-0029070-A1 and 2004-0029071-A1, which applications are incorporated herein by reference.

Referring now to FIGS. 3, 4 and 10, the stand portion 38 of the mold support member includes a stand base 70, a bore portion 72 mounted to the stand base, a threaded shaft 74 insertable into the bore portion 72, a nut 76 secured to the bore portion 72, and an engagement plate 78 positioned adjacent to the base member 12 on an opposite side of top surface 44 from the stand base 70. The exploded view of FIG. 10 illustrates the relative positioning of these various features and how they may be assembled.

The nut 76 is secured to bore portion 72, but is rotatable relative to the bore portion 72. The threaded shaft 74 engages internal threads of the nut 76 whereby rotation of the nut 76 moves the thread shaft 74 within bore portion 72. In other embodiments, the nut 76 may be eliminated and the bore portion may include internal threads that engage the threads of the shaft 74.

The stand base 70 and engagement plate 78 are secured to each other and configured such that a connecting member 80 extending between the stand base 70 and engagement plate 78 may move within a bore 82 formed in the base member 22. This arrangement allows the stand portion 38 to move in the X-Y plane relative to base member 22 when locking mechanism 46 has disengaged locking portion 52 from the engagement plate 78. When the locking portion 52 engages engagement plate 78, the stand portion 38 is locked or otherwise fixed against top surface 44 in a given X-Y position.

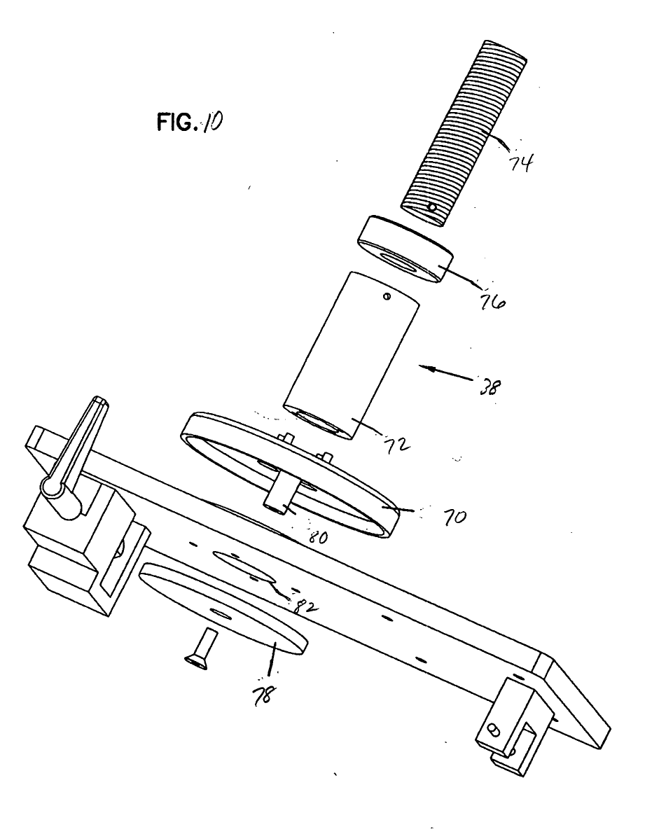

Referring now to FIG. 11, the mold support 26 includes a mold platform adjuster 84 that includes a ball 86, socket 88, an upper portion 90, and a lower portion 92. The platform adjuster 84 provides pivotal adjustment of the mold platform 40 relative to stand portion 38 and the model base support member 24. The ball 86 and socket 88 are retained between the upper portion 90 and a lower portion 92. Socket 88 is adjusted with an adjuster handle 94 that through rotation can loosen or tighten the socket 88 thereby providing adjustment of the mold platform 40 into a desired pivoted position. Lower portion 92 is secured to threaded shaft 74 of the stand portion 38, whereby vertical adjustment of the shaft 74 also vertically adjusts the position of the mold platform 40 and mold platform adjuster 84.

In other embodiments, the mold platform adjuster 84 may be configured differently while performing the same or similar function. For example, another example adjuster may include a ball and a set screw that is inserted through the upper or lower member to lock the mold platform in a given pivotally adjusted position. In another example embodiment, the mold platform may be hinged to the stand portion so that it is adjustable in a single plane of motion rather than through the infinite pivotal adjustment provided by the ball and socket arrangement shown in the Figures. In yet another example, the adjuster may include two or more separate hinges providing adjustment in separate planes of motion, wherein each hinge may be individually fixed thereby allowing the platform to be adjusted in multiple directions relative to the stand.

The mold platform 40 is configured to mount an opposing dental model base 16, 216 as shown in FIGS. 1-4, 6 and 7. To assist in retaining the opposing base 16 on the platform 40, the platform 40 includes a front stop 96, a rear stop 98, and retaining arms 99, 100, 101. The platform may also include indexing tabs 102 on a bottom side thereof that engage apertures 104 that are formed on a top side of platform support 42 (see FIGS. 3 and 4). The indexing tabs 102 help retain the platform 40 relative to the stand 38. The platform 40 further includes an alignment marker 97 that helps to align the front stop 96 with a female index pin 152 (see FIG. 4) of the opposing base 16 when mounting the opposing base 16 to the platform 40.

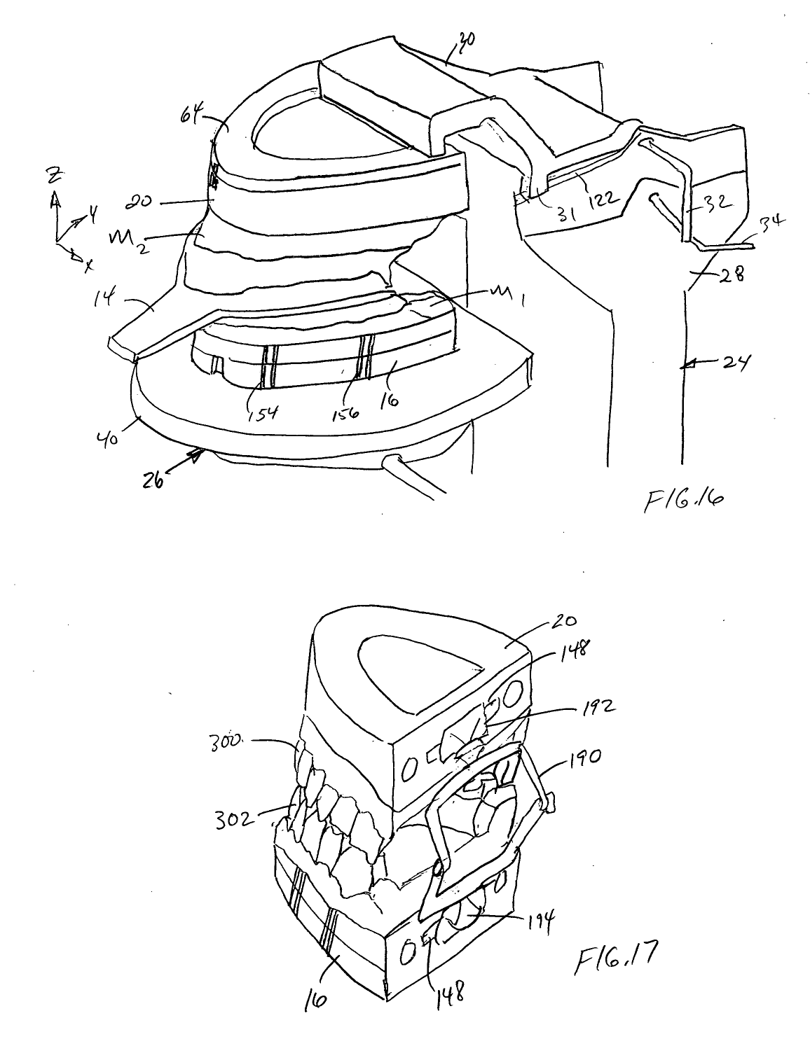

The retaining arms 99, 100, 101 are sized and arranged to extend into a slot 148, 248 formed in a rear side of the opposing base 16, 216. The slot 148, 248 provides structure for coupling the opposing base 16, 216 to, for example, a disposable articulator (e.g., articulator 190 shown in FIG. 17) or other types of mounting devices. The slot 148 in opposing base 16 extends continuously across a back side of the opposing base and is sized such that all three of the retaining arms 99, 100, 101 can extend into the slot 148. The opposing base 16 is retained vertically by the retaining arms 99, 100, 101 and is retained laterally and longitudinally by the front and rear stops 96, 98. For the quadrant opposing base 216 (see FIG. 6), one of the retaining arms 99 or 101 extend into the slot 248 depending on which side of the mold platform 40 the opposing base 216 is positioned, and the retaining arm 100 extends outside of the slot along a side edge of the opposing base 216. This arrangement of one of the retaining arms 99, 101 inside the slot 248 and the retaining arm 101 along a side of the opposing base 216 helps to restrict movement of the opposing base 216 in both the lateral (X) and vertical directions (Z). The opposing base 216 is retained in the longitudinal direction (Y) and partially in the lateral direction by the stops 96, 98.

The mold platform 40 includes a skirt 105 that protrudes downward from the bottom side of the mold platform (see FIG. 4). The skirt 105 is sized to extend around at least a portion of an outer periphery of the platform support 42. The skirt 105 assists the indexing tabs 102 in retaining the mold platform 40 in predetermined lateral and longitudinal position on the platform support 42. In alternative embodiments, the mold platform 40 may be secured to the platform support 42 with a quick release feature, such as, for example, a snap-fit, an interference fit, fasteners, latches or other known features providing a relatively quick release between two or more objects. In yet further embodiments, other features of the mold support member may be detachable from the pouring jig using a quick release or other detachable configuration. For example, various features of the stand portion of the mold support member may be detachable, or even the entire mold support member may be easily and quickly detachable from the pouring jig.

The detachability of at least the mold platform of the mold support member may be advantageous for several reasons. Detachment and attachment of the mold platform 40 by itself or with other features of the mold support may help optimize use of the pouring jig. For example, some preliminary steps in the modeling process using the pouring jig can be done using only the mold platform feature of the pouring jig. These steps can be performed with the mold platform is detached from the pouring jig and the remaining steps can be completed by attaching the mold platform to the pouring jig as needed. Some example steps that can be taken with the mold platform detached include mounting the opposing dental model base to the mold platform, filling the opposing base and the dental mold with moldable material, positioning the filled opposing base and dental mold in engagement with each other, and curing the moldable material. Thus, multiple dental molds and opposing bases may be mounted to separate mold platforms that are all detached from the pouring jig, and then the prepared mold platforms (prepared by properly mounting a dental mold and opposing base) can be quickly mounted one at a time to the pouring jig to form a dental model using the other pouring jig features.

The pin locator 18, attachment plate 64, and dental model base 20 include either a socket or ball attachment feature 108, 110. The ball features 108 are hemispherical shaped protrusions that are configured to at least partially fit within the hemispherical shaped recesses or sockets 110. The fit between the ball 108 and socket 110 may provide a snap fit connection. In the illustrated embodiment, the ball and socket 108, 110 do not engage in a locked arrangement, but rather provide vertical and lateral motion restriction. Engagement of latch features 112, 114, one of which is provided on a front end of the pin locator 18, attachment plate 64, and dental model base 20, provide a snap fit positive connection. In some embodiments, the ball feature may be integrated into the pin locator 18 and dental model base 20 and the socket feature may be integrated into the attachment plate 64. Other embodiments may include any combination of the latch features 112, 114 and the ball and socket features 108, 110 on opposing ends of the pin locator 18, attachment plate 64, and dental model base 20. Other attachment features providing the same or similar attachment function between the attachment plate 64 and the pin locator 18 and dental model base 20 may be provided in other embodiments.

U.S. Published Patent Applications Nos. 2004/0029070-A1 and 2004/0029071-A1 disclose details related to a dental modeling processes wherein the dental mold is directly attached to the mold platform of the mold support member using some type of attachment means (e.g., plaster, fastener, etc.). The dental modeling system and methods disclosed herein include an opposing dental model base 16 positioned between the mold platform 40 and the dental mold 14, 214. This orientation results in the dental mold 14, 214 being raised in height relative to the base member 22 and second portion 30 of the model base support 24 a distance equal to the thickness of the opposing base 16, 216. As a result of this increased height of the dental mold, the second portion 30 should also be raised so that there remains an ample range of vertical adjustment available in the mold support 26.

The extension 36 of the model base support 24 provides an increase in height of the second portion 30 a distance substantially the same as the thickness of the opposing base 16. The extension 36 includes structure that mates with a top surface of the first portion 28 so that the extension 36 is fully supported. The extension 36 includes two sets of apertures 116, 118 that extend laterally in a direction parallel to mating lateral apertures 120 in the first portion 28. A lower of the sets of apertures 116 are configured to receive the first pivot rod 32 to secure the extension 36 to the first portion 28. An upper of the sets of apertures 118 are configured to receive the second pivot rod 34 to secure the second portion 30 of the model base support 24 to the extension 36.

The extension 36 also includes first and second stop surfaces 122, 124. The stop surfaces 122, 124 engage the second portion 30 define a position for the second portion 30 adjacent to the mold support 26 and dental mold 14, and a second position wherein the second portion 30 is rotated 180° into a position removed from the mold support 26 and dental mold 14. In other embodiments, the stop surface may provide a different angle of rotation such as, for example, an angle between 90° and 180°.

The extension 36 provides for use of the pouring jig 12 to directly mount the mold to the platform as described in 2004/0029070-A1 and 2004/0029071-A1 when the extension is removed, or for mounting the mold to an opposing base (e.g., base 16) when the extension 36 is added to the first portion 28. In other embodiments, the first portion 28 may include addition height equal to the height of extension 36, thereby eliminating the need for the extension 36 but possibly restricting the use of the pouring jig. In still further embodiments, the extension 36 may not be needed if, for example, the mold support 26 provides additional vertical adjustment capabilities, or the model support 24 includes other vertical adjustment features.

Referring to FIGS. 4 and 5, the full arc opposing dental model base 16 includes an exterior wall 130, an interior wall 132, and an intermediate wall 134. The exterior and interior walls 130, 132 follow generally the curvature of a patient's gum line. The wall 130, 132, 134 define first and second cavities 136, 138 on opposing sides of the intermediate wall 134. The exterior and interior walls 130, 132 also define opposing first and second support surfaces 140, 142. A latch receiver 114 is formed in a front end of the exterior wall 130, and sockets 110 and a slot 148 are formed in a rear end of the exterior wall 130. A plurality of stone retaining pins 150 and a female index pin 152 extend from the intermediate wall 134 into the first and second cavities 136, 138, respectively. Front and rear pairs of teeth alignment markers are also formed on the exterior wall 130 between the front and rear ends of the opposing base 16.

Referring to FIGS. 6 and 8, the quadrant opposing dental model base 216 includes an exterior wall 230, an interior wall 232, and an intermediate wall 234. The exterior and interior walls 230, 232 follow generally the curvature of a patient's gum line. The walls 230, 232, 234 define first and second cavities 236, 238 on opposing sides of the intermediate wall 234. The exterior and interior walls 230, 232 also define opposing first and second support surfaces 240, 242. A pair of latch receivers 212, 213 are formed in a front end of the exterior wall 230, and a socket 210 and a slot 248 are formed in a rear end of the exterior wall 230. First and second sets of stone retaining pins 250, 251 and first and second female index pins 252, 253 extend from the intermediate wall 234 into the first and second cavities 236, 238, respectively. Front and rear pairs of teeth alignment markers are also formed on the exterior wall 230 between the front and rear ends of the quadrant opposing base 216.

The intermediate wall 134, 234 is spaced evenly between the first and second support surfaces 140, 240 and 142, 242. This even spacing provides cavities 136, 236 and 138, 238 that are substantially the same volume. The use of an intermediate wall may help reduce the total amount of moldable material that is required to form the opposing dental model using the opposing base 16, 216. The intermediate wall also provides two separate cavities wherein each cavity can provide a specific function. In the case of the quadrant opposing base 216, both cavities 236, 238 include features preferred for retaining stone as a base for a dental model such as the stone retaining pins 260, 251, and also include a female indexing pin 250, 251 for mounting to the mold platform 40. This configuration permits the opposing base 216 to function as either a right or left side quadrant opposing dental model base. In other embodiments, one of the female pins 252, 253 and one of the sets of stone pins 250, 251 may be removed similar to the features of opposing base 16 so that the opposing base 216 functions as only a right or a left side quadrant dental model base.

In the case of the full arc opposing base 16, the first cavity 136 is configured for retaining stone as a base for a dental model, while the second cavity 138 includes the female index pin 150 for mounting to the mold platform 40. The second cavity 138, while not including stone pins 150, is still capable of being filled with and retaining moldable material for the purpose of, for example, mounting of the opposing base 16 to an articulator with a plaster attachment (e.g., see plaster attachment of quadrant opposing base 216 to articulator 192 in FIG. 19). In other embodiments, the second cavity 138 may include a set of stone pins and a female index pin may be added to the first cavity 136 so that either side of the opposing base 16 can be used to retain moldable material as a base for a dental model.

The stone pins 150, 250, 251 are columnar in shape and are arranged in separate rows that extend adjacent to the exterior and interior walls 130, 230 and 132, 232. In other embodiments, the stone pins may have different shapes, sizes and numbers and may be positioned at different locations within the cavities. The stone pins may also be integrally formed with one or more of the walls 130, 230 and 132, 232 and 134, 234, or may be separately secured to or be removable from the opposing base. The pins 150, 250, 251 may also extend in different directions from different walls of the base 16, 216.

The front and rear teeth alignment markers 154, 254 and 156, 256 provide an alignment marker for alignment of certain teeth in either an upper or a lower dental mold. Typically, the first marker of each set of markers (when moving from the front to the back of the opposing base 16, 216) is intended for alignment with specific tooth impressions in a lower dental mold. The second marker of each set of markers is intended for alignment with specific teeth impressions in an upper dental mold. The markers 154, 254 and 156, 256 may be most useful when forming a dental model on the opposing base without using the pouring jig 12 and pin locator 18. More details related to the use of the alignment marks 154, 254 and 156, 256 is provided below.

The latch receivers 112, 212, 245 and sockets 110, 210 provide one example of an attachment configuration for attaching the opposing bases 16, 216 to, for example, an attachment plate or other feature of a dental modeling system. Other types of attaching means such as fasters, brackets, and quick release devices may be integrated into or operate on the opposing bases 16, 216 to provide a similar attachment function.

The second cavity 138, 238 of the opposing bases 16, 216 could be eliminated and features such as the female index pin 152, 252 that are positioned in the cavity 138, 238 could be moved to another location. For example, intermediate wall 134, 234 or the exterior wall 130, 230 could have a greater thickness and the female index pin 152, 252 or a similar indexing member could be defined within the intermediate wall or the exterior wall. In another example, the female index pin 152, 252 or a similar indexing member could be positioned outside of the exterior wall 130, 230 or the interior wall 132, 232 so that the index pin is positioned to a side of rather than beneath the intermediate wall 134, 234. In some embodiments, the second cavity 13, 238 could be eliminated so that the base 16, 216 has a reduced height and lower profile.

The dental model bases and attachment plates shown and described herein may be replaced with any desired dental model base or attachment plate configuration. Some example further dental model bases and attachment plates include any of the family of attachment plates and dental model bases shown and described in the following list of issued patents and patent applications: U.S. Pat. Nos. D429,815, D430,672, D433,136, D433,754, D444,559, D443,363, D452,009, D452,010, D452,319, D452,320, D452,321, D452,322, D452,566, D452,567, D452,568, D456,904, D457,964, D457,963, D456,903, D457,636, D457,243, D456,902, D457,637, D464,432, D465,027, D464,431, D464,732, D464,733, D468,018, D468,431, D468,432, D481,797, D469,537, 5,775,899, 5,788,489, 5,788,490, 5,800,166, 5,868,569, 5,934,901, 6,471,513 and 6,884,068; and U.S. patent application Ser. Nos. 29/216,697 and 29/216,696, which are incorporated herein by reference in their entirety. This family of patents and patent applications relates to, but is not limited to, attachment plates and dental model bases for modeling full arch and quadrant dental molds.

A more detailed description of one possible dental modeling method using the dental modeling system (e.g., dental model pouring jig, opposing dental model bases, dental model bases, and pin locators) of the present disclosure is described with reference to FIGS. 12-19. The steps described below are not required to be performed in the exact order listed and may be replaced with more or fewer step that may accomplish the intended purpose of the disclosed examples. While most of the method steps are described utilizing a pouring jig and pin locator, it is possible to conduct at least some of these steps without the use of a pouring jig or pin locator. The opposing bases 16, 216 may have particular usefulness in dental modeling methods separate from a pouring jig and pin locator.

The pouring jig 12 is prepared by first selecting the correct attachment plate 64 and second portion 30 of the model base support member 24 for a given size of the dental mold 14. Next, if a triple tray dental mold and an opposing dental model base are to be used in the modeling method, the extension 36 is attached to the first portion 28 of the model base support 24 using the pivot rod 34. The proper sized second portion 30 is mounted to the extension 36 with the pivot rod 32. The second portion 30 with the attachment plate 64 attached is then moved into the first position oriented vertically above the mold platform 40.

The opposing base 16 is then mounted to the mold platform 40 by inserting the retaining arms 99, 100, 101 into the slot 148 of the opposing base 16, and the front stop member 96 of the mold platform 40 is inserted into the female index pin 152 of the opposing base 16. The dental mold 14 is then manually held in position between the opposing base 16 and the pin locator 18 with pins of the pin locator aligned with teeth impressions in a top side of the dental mold 14 (see FIG. 12). The mold support 26 is adjusted using the various adjustment features described above to approximately align the teeth alignment markers 154, 156 with certain teeth impressions in the bottom side of the dental mold 14 while the pins of the pin locator 18 remain aligned with teeth impressions in the top side of the dental mold 14. It is possible to perform a more visual alignment of the dental model 14 with the opposing base 16 rather than alignment using with the markers 154, 156. Markings indicating the location of certain teeth impressions in the top and bottom sides of the dental mold 14 may be made on an exterior side surface of the dental mold 14 to provide easier alignment with markers 154, 156. Visual alignment may be enhanced if the opposing base 16 and pin locator 18 comprise a transparent or semi-transparent material.

The pin locator 18 is intended to duplicate all of the relative locations and dimensions of the model base 20, including pins that may be mounted to the model base 20. The height of the model platform 40 is adjusted so that the pins in the pin locator 18 do not interfere with the mold 14, and the mold 14 is positioned so that teeth impressions in the top side of the mold 14 are roughly aligned with the pins of the pin locator 18.

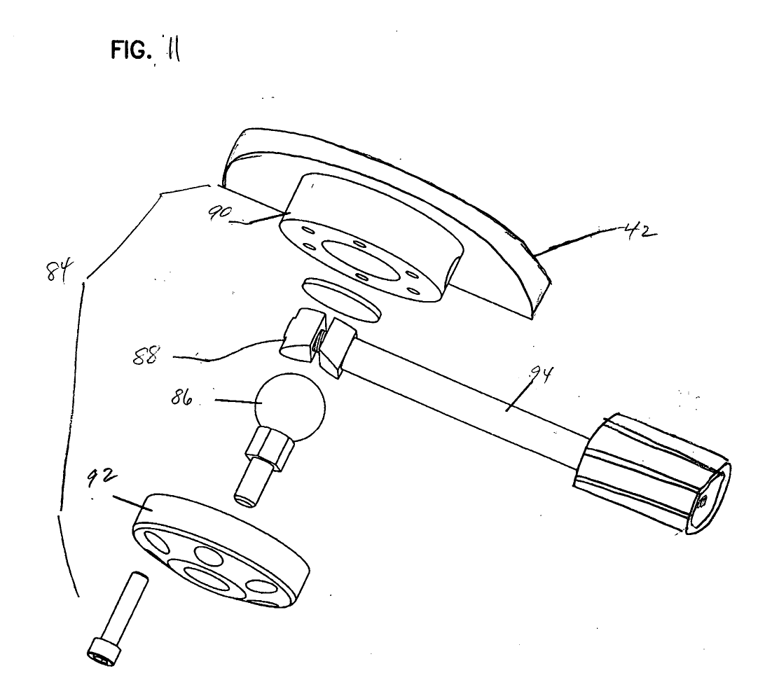

The first cavity 136 of the opposing base 16 and the teeth impressions on the bottom side of the dental mold 14 are then filled with moldable material M₁ as shown in FIG. 13. Filling of the opposing base 16 can be done, for example, while the opposing base 16 and mold platform 40 are mounted on the pouring jig, while the opposing base 16 is removed from the platform 40, or while the opposing base 16 is mounted to the platform 40 and the platform 40 is removed from the pouring jig. These several options provide for optimized use of the pouring jig, if necessary. The moldable material M₁ in the opposing base 16 and dental mold 14 are brought into contact with each other with the alignment markers 154, 156 properly aligned with the teeth impressions in dental mold 14.

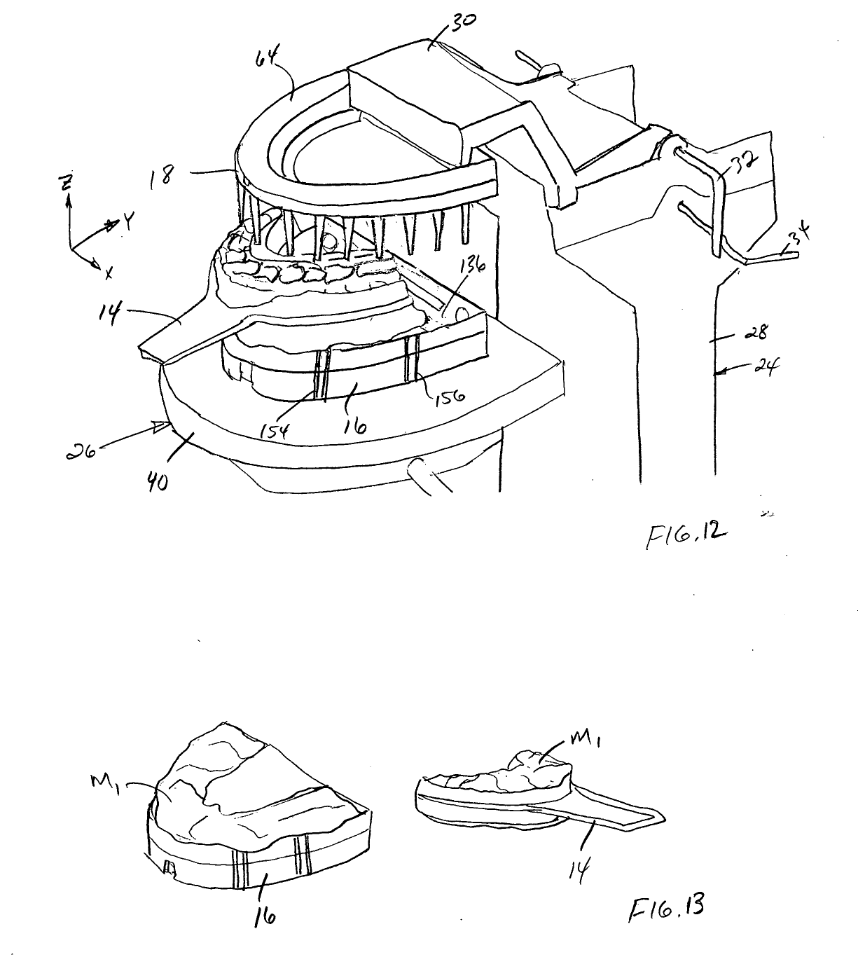

After the moldable material M₁ has cured, the combined opposing base 16 and dental mold 14 are repositioned on the mold platform 40 that is mounted on the pouring jig. The pin locator 18 is again rotated into the first position as shown in FIG. 14 and the mold support 26 is finely adjusted to precisely align and space apart the pin locator pins relative to the teeth impressions of the dental mold 14. The second portion 30 of the model base support 24 is rotated from the first position towards the second position and the pin locator 18 is replaced by the dental model base 20.

In the embodiment shown in FIG. 15, the dental model base 20 includes a plurality of pins 21 extending from a model support surface of the base 20. The model support surface and the teeth impressions on the top side of the dental mold 14 are covered or filled with a moldable material M₂ (see FIG. 14). The second portion 30 is then rotated back to the first position with a contact tab 31 of the second portion engaging stop surface 122 of the extension 36. This rotational motion causes the moldable material M₂ of the dental mold 14 to mate with the moldable material M₂ on the dental model base 20 as shown in FIG. 16.

The filling and covering of dental model base 20 and the top portion of the dental mold 14 with moldable material M₂ can be performed when the base 20 and mold 14 are mounted to the pouring jig or when one or both of those members are removed from the pouring jig. Conducting the filling and covering with material M₂ at a remote location from the pouring jig may help optimize the use of the pouring jig, particularly if the adjusted position of the model support 26 can be accurately reproduced.

After the moldable material M₂ has cured, the dental model base 20 and opposing base 16 can be released from the pouring jig and from the dental mold 14 to expose the resulting dental models 300, 302 (see FIG. 17). Excess moldable material M₁, M₂ can be ground from the models 300, 302 and the models can be mounted to, for example, the disposable articulator 190 shown in FIG. 17. The articulator 190 includes connecting members 192, 194 that engage slot features 148 in the dental model base 20 and opposing base 16. The connecting members 192, 194 may be connected to in the slots 148 with, for example, an adhesive, a snap fit connection, a fastener, ultrasonic welding, etc.

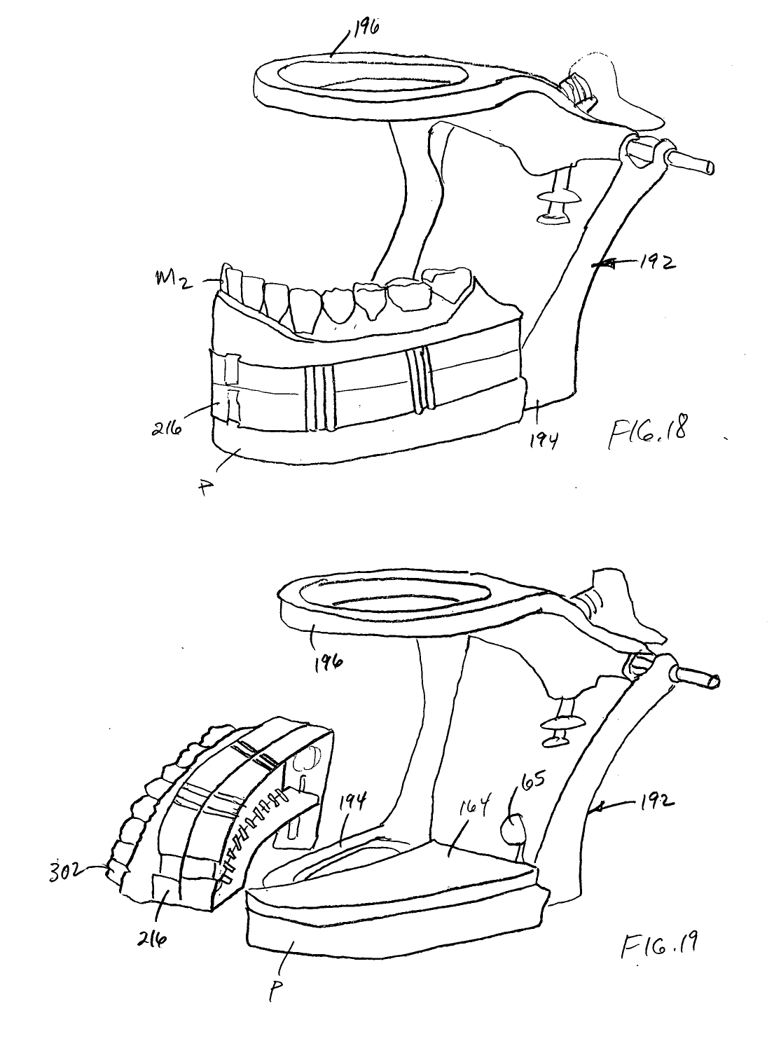

By waiting until after the models 300, 302 have been connected to the articulator to remove the dental mold 14, an accurate alignment of the models 300, 302 that represent a patient's actual bite can be ensured. Maintaining such connection may also improve ease of attaching the dental models 300, 302 to the articulator or other mounting structure. For example, maintaining connection may be useful for attaching to the articulator 192 shown in FIGS. 18 and 19 that require a plaster attachment P to the opposing base 16 and dental model base 20 directly or via an attachment plate 164.

FIG. 18 illustrates a dental model 302 mounted to a quadrant opposing base 216 that is mounted to an articulator 192 with a plaster attachment P. The plaster P is secured to a lower arm 194 and extends into a lower or second cavity 238 of the opposing base 216. The arrangement shown in FIG. 18 provides a permanent connection of the model 302 to the articulator 192 until the plaster attachment P is broken. The model 302, when coupled to the articulator 192 via the plastic attachment P, is held firmly in place while an opposing dental model (e.g., model 300) is connected to the upper arm 196 and while adjustments to the articulator are made to adjust a position of the models relative to each other.

FIG. 19 illustrates a dental model 302 mounted to a quadrant opposing base 216 that is mounted to an articulator 192 with an attachment plate 64. The attachment plate 64 is secured to the articulator arm 194 with a plaster attachment P. The attachment plate provides a quick and simple release of the model 302 from the articulator.

In another modeling system, the first cavity 136, 236 of the opposing base 16, 216 may be filled with moldable material flush with the first support surface 140, 142 and the moldable material is cured. Next, a model of teeth is formed by filling a dental mold 14, 214 with moldable material and curing the moldable material while in the mold 14, 214. The model is removed from the mold 14, 214 and the bottom side (side opposite the teeth) is ground flat. The model is then secured to the support surface 140, 142 with, for example, an adhesive. In this way, the opposing base 16, 216 can provide additional functionality.

Various directions of motion and adjustment are described herein with reference to the adjustability of various features and parts of the example pouring jig and other features described herein. A “direction of motion” as used herein may be broadly defined to include several different types of motion, such as, for example, rotational motion, translational motion, and pivotal motion, and movement in all directions within that type of motion. For example, there is translational motion in the X, Y and Z axial directions as well as translational motion in each of the XY, XZ, and YZ planes. Rotational motion can also be defined within the context of an XYZ coordinate system. Pivotal motion, although closely related to rotational motion, may be useful in describing the motion of some features of the present disclosure, such as the pivotal motion of platform 40 about a single point defined by the ball and socket connection of the platform 40 to the stand 38.

The various components the modeling system 10 may be made of a variety of different materials. For example, a majority of the components associated with the base member 12, dental model support member 14, and mold support member 16 may be made of metal, metal alloy, polymer-based material, or a reinforced polymer-based material such as, for example, fiberglass-reinforced plastic. The opposing bases 16, 216, pin locator 18, and dental model base 20 preferably comprise a translucent or semi-translucent material that permit viewing through or inside of those components when making the various adjustment and alignment steps required in the dental modeling processes discussed herein.

The above specification, examples and data provide a complete description of the manufacture and use of the composition of the disclosed examples. Since many embodiments of the present disclosure can be made without departing from the spirit and scope of the invention, the invention resides in the claims hereinafter appended.

We claim:

1. A dental modeling system, comprising:
a model base having a first model support surface configured for mounting a model of at least some of a person's upper or lower teeth;
an opposing model base defining a second model support surface configured for mounting an opposing model of at least some of the person's teeth that are aligned opposite in a patient's mouth from the teeth model mounted on the model base; and
a pouring jig, including:
a support base;
a mold support member mounted to the support base, the mold support member including a stand, a mold platform supported on the stand, and adjustment featured configured to adjust the mold platform relative to the support base, the platform being configured to releaseably mount the opposing model base; and
a model support member mounted to the support base, the model support member being configured to support the model base in a position generally vertically above the opposing model base.

2. The dental modeling system of claim 1, wherein the model support member includes a first portion mounted to the support base and a second portion pivotally mounted to the first portion.

3. The dental modeling system of claim 2, wherein the model support member further includes an extension member positioned between the first and second portions, the extension member being configured to increase a vertical height of the second portion relative to the platform.

4. The dental modeling system of claim 3, wherein the extension member has a height substantially equal to a height of the opposing model base.

5. The dental modeling system of claim 1, wherein the platform is detachable.

6. The dental modeling system of claim 1, wherein the platform includes at least first and second indexing members configured to retain the opposing model base to the pouring jig.

7. The dental modeling system of claim 6, wherein the first indexing member is configured as a cylindrical shaped protrusion that engages the opposing model base, and the second indexing member includes at least one protrusion configured to engage a slot formed in an end surface of the opposing model base.

8. The dental modeling system of claim 1, wherein at least one of the model base and the opposing model base includes opposing first and second ends, a latch recess defined in the first end, and a hemispherical recess defined in the second end, wherein the latch recess is configured to engage a latch protrusion of a snap fit connection and the hemispherical recess is configured for engagement by a hemispherical protrusion of a ball and socket connection.

9. A method of forming a dental model from a mold of person's teeth using a dental modeling system, the dental modeling system including an opposing model base, a model base, and a pouring jig, the pouring jig including a mold support member and a model support member, the mold including impressions of a patient's opposing upper and lower teeth formed on opposite sides of the mold, the method comprising the steps of:
mounting the opposing model base to the mold support member;
filling the opposing model base and teeth impressions on one side of the mold with a first moldable material and mating the filled first moldable material;
mounting the model base to the model support member;
aligning the model base with teeth impressions on an opposing side of the mold;
filling the opposing side of the mold with a second moldable material and mating the filled second moldable material with the model base;
curing the first and second moldable materials to form a dental model that includes opposing top and bottom teeth; and
removing the mold from the cured moldable material.

10. The method of claim 9, wherein the system further includes a pin locator, and the method further includes mounting the pin locator to the model support member, aligning pins of the pin locator with teeth of the opposing side of the mold, and removing the pin locator before mounting the model base to the model support member.

11. The method of claim 9, wherein the mold support member includes a stand and a platform, wherein the platform is pivotally mounted to the stand, the platform being configured to releaseably mount the opposing model base.

12. The method of claim 9, further comprising vertically adjusting the stand to alter a vertical position of the platform when aligning the model base with teeth impressions on an opposing side of the mold.

13. The method of claim 11, wherein the platform includes first and second members, the first member being coupled to the stand with a ball and socket connection to provide pivotal movement, and the second member including a generally planar mounting surface and a plurality of attachment members configured to support and retain the opposing model base.

14. The method of claim 9, wherein the model base is mounted to the model support member with a ball and socket connection at one end of the model base and a snap fit latch connection at an opposing end of the model base.

15. The method of claim 9, wherein the pouring jig further comprises an model support member extension configured to increase a height of the model support member relative to the mold support member a distance substantially equal to a height of the opposing model base, the method further comprising mounting the extension to the model support member prior to the step of mounting the model base to the model support member.

16. An dental model base, comprising:
a bottom wall;
a continuous sidewall extending generally vertically upward from the bottom wall and defining a top support surface along a top edge of the sidewall, wherein the bottom wall and the sidewall define a first cavity;
a plurality of retaining pins extending generally vertically upward from the bottom wall into the cavity; and
a first attachment feature defined in a front end of the sidewall and a second attachment feature defined in a rear end of the sidewall.

17. The dental model base of claim 16, further comprising a first mounting alignment member extending vertically downward from the bottom wall.

18. The dental model base of claim 16, wherein the sidewall and the bottom wall are integrally formed as a single piece.

19. The dental model base of claim 16, wherein the first latch feature includes a latch recess configured for a snap-fit connection, and the second latch feature includes either a hemispherical shaped recess or a hemispherical shaped protrusion configured for a ball and socket connection.

20. The dental model base of claim 16, further comprising a second continuous sidewall extending generally vertically downward from the bottom wall and defining a bottom support surface along a bottom edge of the second sidewall, wherein the bottom wall and the second sidewall define a second cavity separated from the first cavity by the bottom wall.

21. The dental model base of claim 16, further comprising a plurality of retaining pins extending generally vertically downward from the bottom wall into the second cavity.

22. The dental model base of claim 16, further comprising a second mounting alignment member extending vertically upward from the bottom wall into the first cavity.

23. The dental model base of claim 16, further comprising indexing members formed in an outward facing surface of the sidewall, the indexing members providing a guide for alignment of a predetermined tooth of a dental mold.

24. The dental model base of claim 16, further comprising a slot formed in a rear end of the sidewall, the slot being configured for attachment of the opposing dental model base to an articulator.

25. A dental model pouring jig, comprising;
a base member defining a planar mounting surface;
a model base support member extending vertically from the mounting surface and including an attachment structure for detachably mounting a dental model base;
a mold support member extending vertically from the mounting surface, the mold support member being adjustably secured to the base member and comprising a detachable mold platform, the mold platform being configured to mount an opposing model base, the mold support member being vertically adjustable relative to the model base support member to change a position of the mold platform relative to the model base support member;
wherein the model base support member further comprises an extension member configured to increase a height of the model base support member relative to the mold platform, the opposing model base being configured to support a model of teeth from a first side of a mold of a person's teeth, and the dental model base being configured to support a model of teeth from a second side of the mold.

26. The pouring jig of claim 25, wherein the mold support member is adjustable in at least two planes relative to the mounting surface of the base member.

27. The pouring jig of claim 25, wherein the mold platform includes a mold mounting surface and at least first and second indexing member extending from the mold mounting surface, the first and second indexing members being configured to couple the opposing model base to the mold platform.

28. The pouring jig of claim 25, wherein the mold support member further includes a stand coupled between the mold platform and the base member, the stand being vertically adjustable to alter a height of the mold platform relative to the base member, and the mold platform is connected to the stand with an adjustable ball and socket connection.
